(19) United States
(12) Patent Application Publication
(10) Pub. No.: US 2016/0042409 A1
(43) Pub. Date: Feb. 11, 2016

(54) CONTENT CREATION AND MANAGEMENT FOR ELECTRONIC ADVERTISING DISPLAYS

(71) Applicant: Jani Gyllenberg, Lake Worth, FL (US)

(72) Inventor: Jani Gyllenberg, Lake Worth, FL (US)

(21) Appl. No.: 14/455,839

(22) Filed: Aug. 8, 2014

(51) Int. Cl. G06Q 30/02; H04L 29/06

(52) U.S. Cl. CPC G06Q 30/0276; H04L 67/42

(57) ABSTRACT

Arrangements relate to the creation, management and/or publication of advertising content. One or more user inputs corresponding to information relating to an item can be received. One or more user inputs corresponding to image content relating to the item can be received. Advertising content can be created. The advertising content can include at least a portion of the image content relating to the item and at least a portion of the information relating to the item. In response to receiving a user input corresponding to one or more selected displays, the created advertising content can be published to the one or more selected displays for presentation.

### FIELD

Arrangements relate in general to advertising and, more particularly, to electronic advertising.

### BACKGROUND

In many showrooms (e.g. automobile dealerships, boat dealerships or other retail settings), signage is used to convey information about a product, such as price, features, etc. The signage may be in the form of a price sign or a window sticker. The signage is usually located on or near the product. Such signage typically includes a substrate (e.g. paper, cardboard or poster board) upon which information is presented. The information can be written upon the substrate, or it can be attached to the substrate using attachable elements like stickers or static clings. The information presented does not change unless manually updated or the signage is replaced.

### SUMMARY

In one respect, arrangements are directed to a method of creating and publishing advertising content, the method. The method can include receiving one or more user inputs corresponding to information relating to an item. The method can also include receiving one or more user inputs corresponding to image content relating to the item. Further, the method can include creating, via a processor, advertising content. The advertising content can include at least a portion of the image content relating to the item and at least a portion of the information relating to the item. The method can also include, responsive to receiving a user input corresponding to one or more selected displays, publishing the created advertising content to the one or more selected displays for presentation thereon.

In another respect, arrangements are directed to a system of creating and publishing advertising content. The system includes a processor. The processor is programmed to initiate executable operations. The executable operations can include receiving one or more user inputs corresponding to information relating to an item. The executable operations can also include receiving one or more user inputs corresponding to image content relating to the item. The executable operations can further include creating advertising content. The advertising content can include at least a portion of the image content relating to the item and at least a portion of the information relating to the item. The executable operations can include, responsive to receiving a user input corresponding to one or more selected displays, publishing the created advertising content to the one or more selected displays for presentation thereon.

In still another respect, arrangements are directed to a system. The system includes a plurality of electronic displays and a processor communicatively coupled to the plurality of electronic displays. The processor is programmed to initiate executable operations. The executable operations can include receiving one or more user inputs corresponding to information relating to an item. The executable operations can also include receiving one or more user inputs corresponding to image content relating to the item. The executable operations can further include creating advertising content. The advertising content can include at least a portion of the image content relating to the item and at least a portion of the information relating to the item. The executable operations can include, responsive to receiving a user input corresponding to a selected one or more of the electronic displays, publishing the created advertising content to the one or more selected electronic displays for presentation thereon.

### BRIEF DESCRIPTION OF THE DRAWINGS

FIG. 1 is an example of a system for creating, managing and/or publishing content for electronic advertising displays.

FIG. 2 is an example of an electronic advertising display.

FIG. 3 is an example of a product information page.

FIG. 4 is an example of a presentation build page.

FIG. 5 is an example of a send to display page.

FIG. 6 is an example of a method of creating and publishing content for electronic advertising displays.

FIG. 7 is a block diagram illustrating an example of a system for creating and managing and/or publishing content for electronic advertising displays.

### DETAILED DESCRIPTION

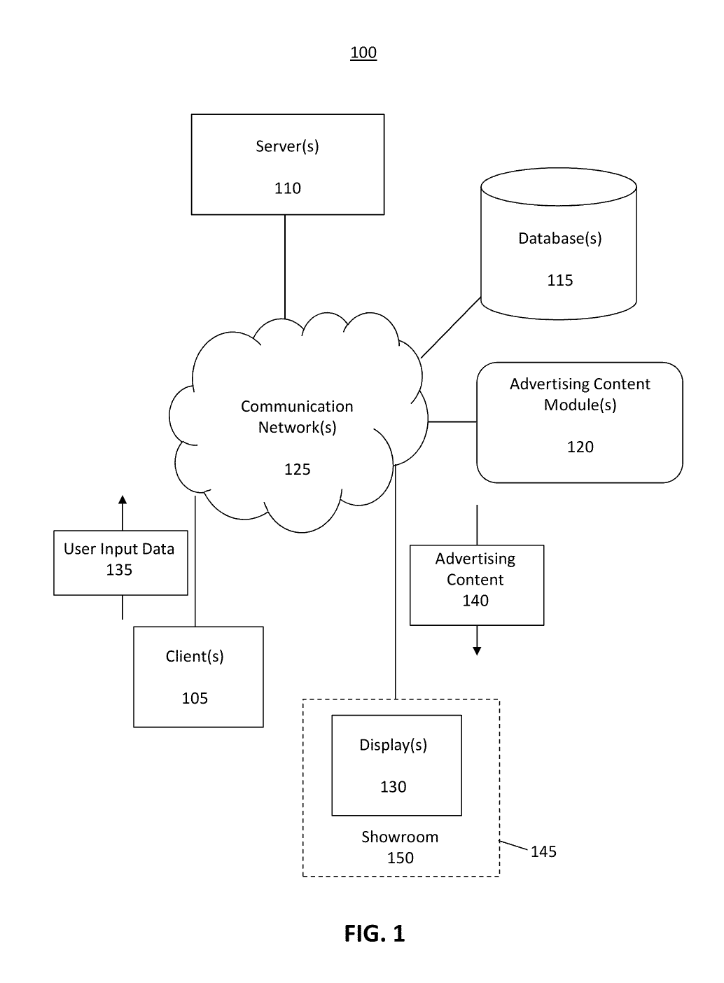

Arrangements described herein relate to creating, managing and/or publishing content for electronic advertising displays. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 1-7, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIG. 1 depicts a block diagram illustrating system for creating, managing and/or publishing content for electronic advertising displays in accordance with one embodiment disclosed within this specification. The system 100 can include one or more clients 105, one or more servers 110, and one or more databases 115. The system 100 further can include one or more advertising content modules 120. Further, the system 100 can include one or more displays 130.

The various components of system 100 can be communicatively linked through one or more communication networks 125. As used herein, the term “communicatively linked” can include direct or indirect connections through a communication channel or pathway or another component or system. A “communication network” means one or more components designed to facilitate the delivery of information from one source to another.

The one or more communication networks 125 can be implemented as, or include, without limitation, a wide area network (WAN), wireless wide area network (WWAN), a local area network (LAN), wireless local area network (WLAN), the Internet, the Public Switched Telephone Network (PSTN), a wireless network, a mobile network, a Virtual Private Network (VPN), the Internet, and/or one or more intranets. The communication network(s) 125 can include any combination of the above networks and/or other types of networks. The communication network(s) 125 can include one or more routers, switches, access points, wireless access points, and/or the like.

As noted above, the system 100 can include one or more clients 105. The client(s) 105 can be used by one or more users (e.g. one or more persons). The client(s) 105 can be implemented as any of a variety of communication devices executing suitable communication software. The client(s) 105 can be any suitable device that can allow a user to access, use, and/or execute the one or more advertising content modules 120. Each client 105 can be implemented as a computer system or other information processing system. One or more of the clients 105 may also be implemented as a portable or mobile computing device (e.g., a mobile telephone, a smart phone, a wireless-enabled personal digital assistant, a portable computer (e.g., laptop, tablet or the like)).

Each client 105 can include and/or execute suitable communication software, which enables the client 105 to communicate with the server(s) 110, database(s) 115, advertising content module(s) 120, display(s) 130 and/or other clients 105 through the communication network 125 and perform the functions disclosed herein. In some instances, the one or more client(s) 105 can be configured to communicate via a wireless and/or wired medium.

The one or more servers 110 can be implemented as, for example, an advertising content creation, management and/or publication system. In this regard, the one or more servers 110 can be implemented as an advertising content creation, management and/or publication server or other communication hub or server capable of executing advertising content creation, management and/or publication processes within or as part of the communication network 125. The one or more servers 110 can include suitable operational software for performing the various functions described herein.

The advertising content module 120 and/or the database 115 can be stored and/or executed on the server 110. Alternatively, the advertising content module 120 and/or the database 115 can be stored and/or executed on one or more other systems, devices, elements or components to which the server 110 is communicatively linked. As an example, the advertising content module 120 and/or the database can be stored and/or executed on one or more of the clients 105.

The advertising content module 120 can be implemented as computer readable program code that, when executed by a processor, implement the various processes described herein. The advertising content module 120 can facilitate the creation, management and/or publication of content to the one or more displays 130 in various ways. For instance, the advertising content module 120 can enable a user to input data 135 relating to goods or services being sold or offered for sale. The advertising content module 120 can enable a user to create and/or modify an advertisement using the input data, uploaded content, and/or other elements available on the system 100. The advertising content module 120 can process data to generate or create advertising content 140. The advertising content module 120 can provide advertising content archiving, storage and/or metrics. The advertising content module 120 can create or generate one or more data structures and/or modify such data structures based on received user input data 135.

The advertising content 140 can include, for example, an advertisement, a presentation, a promotional piece and/or an informational piece in electronic form relating to good(s) and/or service(s). The advertising content 140 can be static content, that is, content that does not change. Alternatively, the advertising content 140 can be dynamic, that is, at least a portion of the content can change (e.g. changes in color, layout, size, shape, brightness, video, a slideshow of individual images and/or videos, etc.).

The system 100 can allow users to submit input data 135 to the advertising content module 120. The input data 135 can include information relating to an item. Alternatively or in addition, the input data 135 can include, for example, text, a document, a file, image content (e.g. images, video, Uniform Resource Locator(s) etc.) and/or audio data. The input data 135 can include a theme or layout for advertising content. The input data 135 can be uploaded by a user and/or selected by the user from a predetermined set of input data. The input data 135 can be transmitted across one or more channels or streams. The advertising content module 120 can record data transmitted across these content channels or streams.

The advertising content module 120 can be configured to convert the input data 135 from one form of data to another. To that end, the advertising content module 120 can include, for example, any known voice recognition, transcription, dictation, speech-to-text or other conversion software. The advertising content module 120 can convert one or more components of the input data 135 so that the input data is in the same data format.

The user input data 135 can be collected in any suitable manner by the advertising content module 120. The collected data can be stored in the database 115.

The advertising content module 120 can process data to selectively publish advertising content 140. “Publish” means delivered, sent, made available or made accessible for presentation or display and/or actually presented or displayed. For instance, the advertising content 140 can be published to one or more of the displays 130 and/or to a computing system.

A “display” is defined as a component or a group of components that present information/data in visual form. The display 130 can be any suitable type of display. The display 130 may be a liquid crystal display (LCD), a light emitting diode (LED) based display or some other suitable display. In one embodiment, the display 130 can be a touch screen display. The touch screen can allows a user to engage or interact with one or more displayed elements, such as a graphical user interface (GUI), and/or other applications through, for example, contact with the display 130. For example, a user may make selections and move a cursor by simply touching the display 130 via a finger or stylus, which may be interpreted by the display 130 to perform an action based on the touch event. In some arrangements, at least one of the displays 130 can be one or the clients 105 or a part of a client 105. One or more of the displays 130 can include a processor or other computing device.

When the system 100 includes a plurality of displays 130, the plurality of displays 130 can be substantially identical to each other. In one or more arrangements, one or more of the displays of the plurality of displays 130 can be different from the other displays in one or more respects.

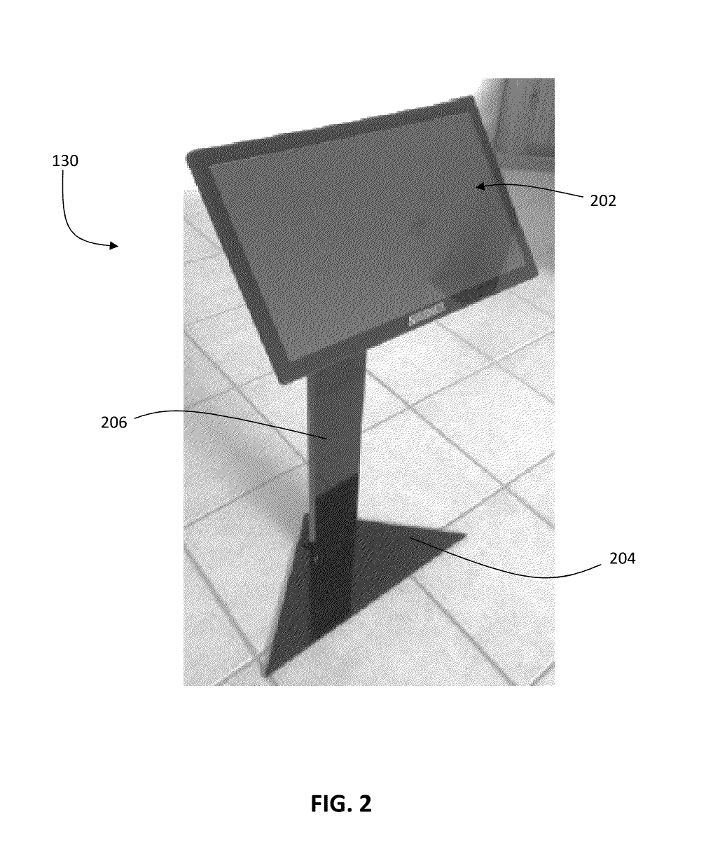

The display 130 can be any suitable type of display. One non-limiting example of a display 130 is shown in FIG. 2. The display 130 can include a screen 202. The display 130 can be configured to be placed in various locations. The display can include a base 204 and a riser 206.

The base 204 can have any suitable configuration. In one or more arrangements, the base 204 can be a substantially flat structure. The base 204 can have any suitable size and/or shape. In one or more arrangements, the base 204 can be substantially triangular, as is shown in FIG. 2. However, it will be understood that the base 204 is not limited to this shape. Indeed, the base 204 can have a substantially rectangular, substantially circular, substantially oval, substantially parallelogram, substantially polygonal, substantially trapezoidal shape, just to name a few possibilities. In some instances, the base 204 can have an irregular shape.

The riser 206 can be substantially straight along its entire length. In one or more arrangements, the riser 206 can be non-straight in one or more regions or across its entire length. As an example, the riser 206 can be curved across its entire length.

The riser 206 can have a substantially vertical orientation. As used herein, the term “substantially” includes exactly the term it modifies and slight variations therefrom. Thus, the term “substantially vertical” means exactly vertical and slight variations therefrom. However, in other arrangements, the riser 206 can be at any suitable non-vertical orientation when arranged in an intended operational position.

The riser 206 can have any suitable length. In one or more arrangements, the length of the riser 206 can be fixed. In one or more arrangements, the length of the riser 206 can be adjustable. The length of the riser 206 can be adjustable in any suitable manner. When a desired length is achieved, the length of the riser 206 can be selectively locked in any suitable manner. When configured to be adjustable, the length of the riser 206 can have any suitable range of adjustment.

In one or more arrangements, the display 130 can be configured as a free standing structure, as is shown in FIG. 2. In this respect, the display 130 can be readily moved, arranged, and/or positioned.

The display 130 can be powered in any suitable manner. For instance, the display 130 can be operatively connected to a suitable power source in any suitable manner. As an example, the display 130 can be configured for connection to an alternating current socket or outlet. As another example, the display can be powered by any suitable self-contained power source (e.g. a battery).

In some arrangements, one or more of the displays 130 can be configured so that, upon start-up, communication with one or more portions of the system 100 (e.g. the server(s) 110 and/or the advertising content module(s) 120) can be established. Once communication is established, the display 130 can query the server(s) 110 and/or advertising content module(s) 120 to determine whether an advertisement or presentation is prepared for that particular display 130. Other devices, systems and/or components of the system 100 can be updated to indicate that a new display is detected and/or is available for use.

In one or more arrangements, the one or more display 130 can be located in any suitable environment 145. One example of an environment 145 is a showroom 150. “Showroom” means a space used display, offer for sale, advertise, and/or promote good(s) and/or service(s). The showroom 150 can be a showroom for a motorized vehicle. For instance, the showroom can be for automobiles (e.g. an automobile dealership), watercraft (e.g. a boat dealership), aircraft and/or any other form of mechanized transport. However, arrangements described herein are not limited to use in connection with such products. Indeed, arrangements described herein can be associated with any product or service being sold or offered for sale. Further, the environment 145 can be an indoor environment or an outdoor environment. The environment 145 can be a retail or wholesale store or setting.

When a plurality of displays 130 is provided, the plurality of displays 130 can be located in the same environment 145. Alternatively, when a plurality of displays 130 is provided, the plurality of displays 130 can be located in a plurality of environments 145.

The one or more displays 130 can be distributed and/or arranged in the environment 145 in any suitable manner. In one or more arrangements, one or more of the displays 130 can be located proximate to an item (e.g. a product or service) being advertised. The item can be, for example, the product itself or an object associated with a product or service. In one or more arrangements, one or more of the displays 130 can be located on an item being advertised. In one or more arrangements, one or more of the displays can be located in an item being advertised. In one or more arrangements, one or more of the displays can be located proximate to an item being advertised.

The system 100 can provide a user friendly interface that can facilitate the creation, management and/or delivery of advertising content 140 to one or more displays 130. For instance, the system 100 can include a portal. The term “portal” is defined as any combination of components or systems that permit a user or another system or component to input, output, manage, generate, process or manipulate data or to control another component or system and can include hardware, software or any suitable combination of hardware and software. An “interface” is defined as a component, system or arrangement or groups thereof that enable information/data to be entered into a machine. The interface can facilitate advertisers in the creation, management and/or delivery of advertising content for display on one or more of the displays. A “user interface element” is defined as a component or a group of components that enables a user to interact with a machine. One example of a user interface element is a graphical user interface element. The term “graphical user interface element” is defined as an image or a portion of an image that presents information to a user or allows the user to interact with a device through a display.

A user of the system can access a portal for carrying out the features described herein. Access to the portal can be achieved in any suitable manner. For instance, access to the portal may be via an Internet-based portal accessible to any browser-enabled system or device. As another example, access to the portal may be by way of any suitable portable computing device equipped with an appropriate software application. The portal can present a user interface to allow users to create, manage, and/or publish advertising content. More particularly, the portal can present a user interface to allow users to create, manage, and/or publish advertising content for display on one or more of the advertising displays described herein. The portal can also present a user interface to allow a user to input any of the user input data described herein. The portal can be accessed by one or more of the clients 105 and/or one or more of the displays 130.

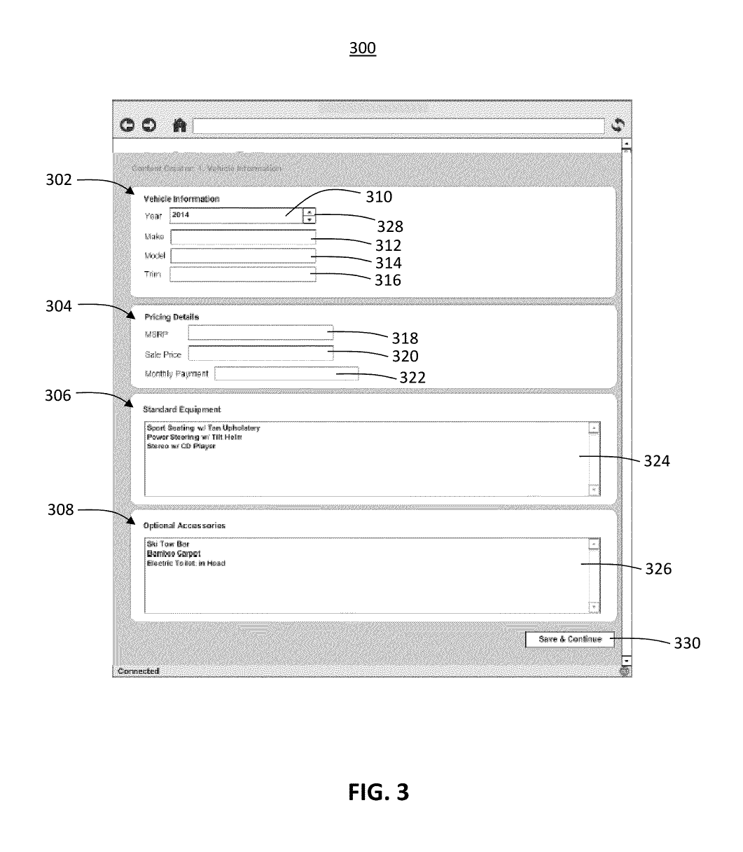

Various possible pages and input fields for the portal will now be described in connection with FIGS. 3-5. However, it will be understood that these pages and input fields are provided merely as examples. Indeed, there can be additional or fewer pages and/or input fields. Further, the pages and/or input fields can be arranged and/or configured differently than those shown in FIGS. 3-5. In addition, while the pages and/or inputs fields shown in FIGS. 3-5 are shown in connection with the sale of form of mechanized transport, it will be appreciated that the pages and/or input fields may vary based on the type of goods or services being sold and/or the associated type of business or industry.

Referring to FIG. 3, the portal can include a product information page 300 that can be presented to a user. The product information page 300 may also present one or more features to enable a user to input, edit and/or remove information relevant to an item. In this context, the term “item” means good(s) and/or service(s) being sold, offered for sale, advertised, displayed and/or promoted.

The product information page 300 can include one or more fields to receive a user input. Any suitable type of field can be presented to the user. For instance, in the context of a motorized vehicle, the product information page 300 can present an item detail field 302, a pricing field 304, a standard equipment field 306 and/or an optional accessories field 308. It will be understood that these fields are provided merely as examples, and arrangements are not limited to any particular field or combination of fields. Moreover, there can be additional, fewer or different fields to those shown in FIG. 3.

In some instances, one or more of the fields can be empty (that is, not pre-populated with information), such as when new advertisement is being created. In other instances, one or more of the fields can be pre-populated with information, such as information from a previously input advertisement, system default information or other information. In such instances, a user may select to keep at least a portion of the pre-populated information, or a user can delete, replace, edit and/or add to at least a portion of the pre-populated information.

The item detail field 302 can be configured to receive one or more user inputs relating to any suitable information about an item being sold, offered for sale or advertised. In one or more arrangements, the item detail field 302 can present a window, region, area, field or space to allow a user to input information in a freeform manner. In one or more arrangements, the item detail field 302 can present one or more subfields to receive and/or facilitate user input. For instance, the item detail field 302 can include one or more subfields to receive a user input with respect to specific characteristics of an item. In one or more arrangements in which the item is an automobile or watercraft, non-limiting examples of possible subfields include: a vehicle year subfield 310, a vehicle make subfield 312, a vehicle model subfield 314 and/or a trim subfield 316. These subfields are provided merely as examples and arrangements are not limited to any particular subfield or combination of subfields. Moreover, there can be additional, fewer and/or different subfields to those shown in FIG. 3. A user can input information into one or more of these subfields or otherwise in the item detail field 302 in any suitable manner.

The pricing details field 304 can be configured to receive one or more user inputs relating to the price of the vehicle. The pricing details field 304 can present a window, field, area, region or space to allow a user to input information in a freeform manner. In one or more arrangements, the pricing details field 304 can present one or more subfields to receive and/or facilitate user input. For instance, the pricing details field 304 can include one or more subfields to receive a user input with respect to the price of an item. In one or more arrangements in which the item is an automobile or watercraft, non-limiting examples of possible subfields include: a Manufacturer's Suggested Retail Price (MSRP) subfield 318, a Sale Price subfield 320 and/or a Monthly Payment subfield 322. These subfields are provided merely as examples and arrangements are not limited to any particular subfield or combination of subfields. Moreover, there can be additional, fewer and/or different subfields to those shown in FIG. 3. A user can input information into one or more of these subfields or otherwise in the pricing details field 304 in any suitable manner.

The standard equipment field 306 can be configured to receive one or more user inputs relating to any standard equipment or features associated with the vehicle. Further, the optional accessories field 308 can allow a user to input information relating to any optional or added accessories, equipment or features to the vehicle. The standard equipment field 306 and/or the optional accessories field 308 can present a field, are, region, space or window 324, 326 respectively to allow a user to input information in any suitable manner, such as by freeform text input. In one or more arrangements, the standard equipment field 306 and/or the optional accessories field 308 can present one or more subfields to receive and/or facilitate user input.

Again, the various fields described above are merely provided as examples. Other fields are possible, such as, for example, an available accessories field and/or a performance data field.

A user can input information into one or more of the fields and/or subfields in any suitable manner. In some instances, the user may have to input data into one or more of the fields manually in any suitable manner. In other instances, a graphical user interface element (e.g. a button 328, a drop-down menu, etc.) can be provided to facilitate the user's input. In such case, the graphical user interface element may provide the user with one or more predetermined choices for the field.

After the desired information is input, a user can select a user interface element (e.g. a “Save & Continue” button 330) to save the input information for quick access in the future, possibly in connection with a different campaign. Such a user interface element can take the user to another screen or portion in the content creation process.

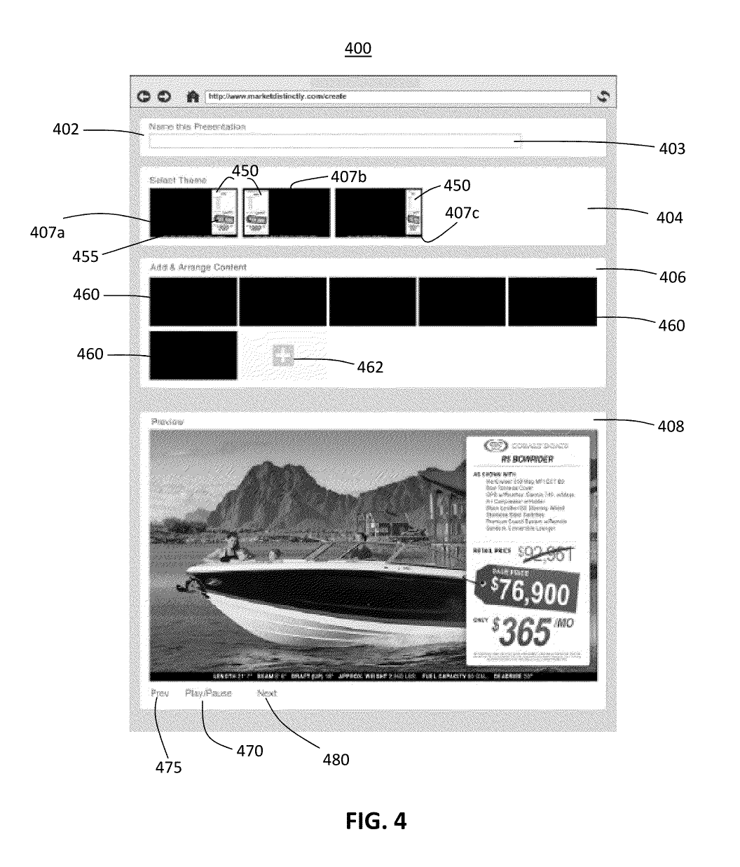

Referring to FIG. 4, the portal can include a build presentation page 400 that can be presented to a user. The build presentation page 400 may also present one or more features to enable a user to design, configure, arrange and/or layout advertising content for an item.

The build presentation page 400 can include one or more fields to receive a user input. Any suitable type of field can be presented to the user. For instance, the build presentation page 400 can present a presentation name field 402, a theme field 404, an add and arrange content field 406 and/or a preview field 408. It will be understood that these fields are provided merely as examples, and arrangements are not limited to any particular field or combination of fields. Moreover, there can be additional, fewer or different fields to those shown in FIG. 4.

In some instances, one or more of the fields can be empty (that is, not pre-populated with information), such as when new advertising content is being created. In some instances, one or more of the fields can be pre-populated with information, such as information from a previously input advertisement, system default information or other information. In such instances, a user may select to keep at least a portion of the pre-populated information, or a user can delete, replace, edit and/or add to at least a portion of the pre-populated information.

The presentation name field 402 can allow a user to input a name for this advertisement. In one or more arrangements, the presentation name field 402 can present a window, space, area, region or subfield 403 to allow a user to input information in any suitable manner, such as a freeform text input.

The select theme field 404 can be configured to receive one or more user inputs corresponding to a selected theme, arrangement, configuration, look, layout and/or design for advertising content for at least some of the information input on the vehicle information page can be presented. In one or more arrangements, one or more layouts 407a, 407b, 407c can be presented to a user. In one or more arrangements, one or more of the layouts 407a, 407b, 407c can be predetermined. In some arrangements, one or more of the layouts 407a, 407b, 407c can be uploaded, input or created by a user.

The layouts 407a, 407b, 407c can be presented in the select theme field 404 in any suitable manner. For instance, the layouts 407a, 407b, 407c can be presented as graphical user interface elements that can be selected by a user. While FIG. 4 shows three layouts being presented, it will be understood that arrangements are not limited to this quantity. Indeed, there can be more than three layouts or fewer than three layouts.

The layouts 407a, 407b, 407c can have any suitable content and/or arrangement. When a plurality of layouts is provided, the layouts can differ from each other in one or more respects.

In some implementations, at least some of the information input on the item information page 300 can be presented can be displayed on the layouts 407a, 407b, 407c, such as in a graphical representation of an item information element 450. The information can be displayed as text in the item information element 450. The item information element 450 can have any suitable size and/or shape. For instance, the item information element 450 in layouts 407, 407b can be relatively wide and substantially rectangular. The item information element 450 in layout 407c can be relatively narrow and substantially rectangular. While the item information element 450 is shown as being substantially rectangular, it will be understood that the item information element 450 can have any suitable shape, including any irregular shape.

Further, the item information element 450 can include different color elements. As an example, the sale price of the item can be provided on a graphical representation of a price tag 455. Further, the price tag 450 in one of the layouts can be a first color, and the price tag 450 in a different one of the layouts can be a second color that is different from the first color.

The item information element 450 can be located in different regions of the layouts 407a, 407b, 407c. For example, in layouts 407a, 407c, the item information element 450 can be located in a right side region of the layout. In layout 407b, the item information element 450 can be located in a left side region of the layout. However, these locations of the item information element 450 are merely provided as examples. The item information element 450 can be located in any suitable region of a layout. Indeed, other possible locations for the item information element 450 can include a central region of the layout, in an upper region of the layout or in a lower region of the layout.

The add and arrange content field 406 can be configured to receive selected content or input content related to the item being sold, offered for sale or advertised. The content can include, for example, text, a file, images, video, audio data and/or other content. Such content can be uploaded from a local machine or storage device and/or a uniform resource locator (URL) or hyperlink can be provided to content that is hosted online. In one or more arrangements, the content can be image content. The content can be uploaded by a user and/or selected by the user from a predetermined set of content. If a user wishes to add additional content, the user can select a “+” button 462 or other button or user interface element. The different graphical representations of the content 460 shown in FIG. 4 can be selectively arranged in a desired order by a user. As an example, the add and arrange content field 406 can be configured to allow a user to drag and drop a selected one or more of the graphical representations of the content 460 to a desired place among the content.

The preview field 408 can be configured to present a preview of the advertising content built by the user based on previous user inputs received on the item information page 300 and/or the build presentation page 400. Such a preview affords a user the opportunity to review the advertising content to confirm the user's selections and/or inputs before finalization. In instances in which at least a portion of the advertising content is dynamic (e.g. video, audio, and/or a plurality of images), the page can provide a “play/pause” button 470 or other suitable user interface element to allow a user to selectively play or pause the advertising content.

A user may make any desired changes the advertising content. For instance, if the user wishes to change the theme, content or arrangement of the content of the advertising content, then the user can delete, replace, edit and/or add information or data to the appropriate fields on the build presentation page 400. If the user needs to make changes to the information input on the item information page 300 or a prior page, a user interface element, such as “Prev” button 475, can be provided to return the user to such pages. If the user is satisfied with the advertising content, then the user can select the “Next” button 480.

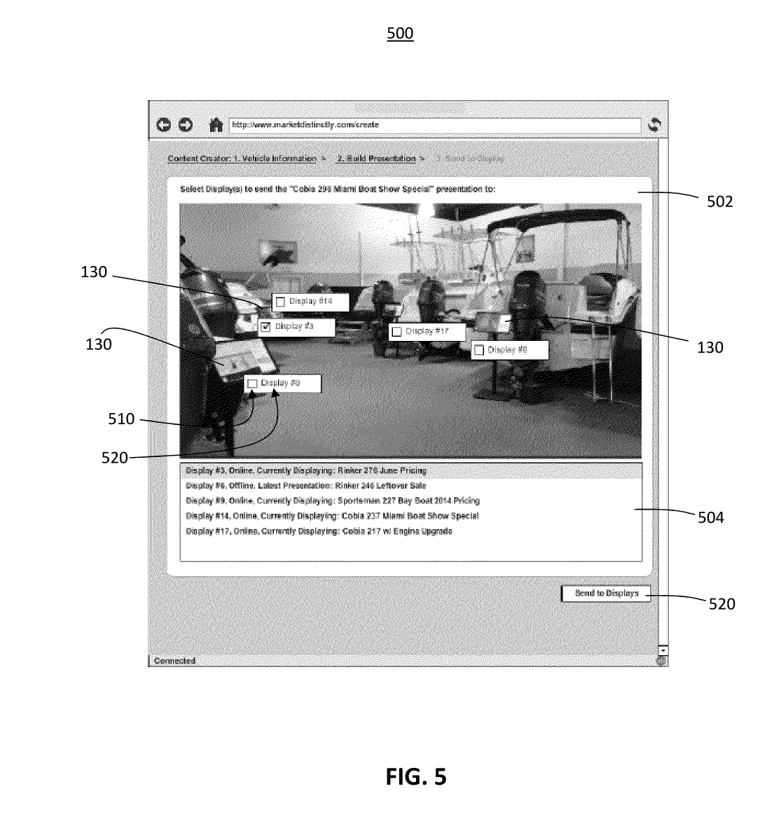

FIG. 5 shows an example of a send to display page 500 that can be presented to a user. The send to display page 500 may also present one or more features to enable a user to selectively assign the advertising content to one or more displays (e.g. displays 130) for presentation thereon.

The send to display page 500 can include one or more fields to receive a user input and/or to provide information. Any suitable type of field can be presented to the user. For instance, there can be a select display field 502 and a display status field 504. It will be understood that these fields are provided merely as examples, and arrangements are not limited to any particular field or combination of fields. Moreover, there can be additional, fewer or different fields to those shown in FIG. 5.

The select display field 502 can be configured to receive one or more user inputs relating to which display(s) that the advertising content will be send to for presentation thereon. The select display field 502 can have any suitable form. For instance, in some arrangements, the select display field 502 can present an image or video of at least a portion of the environment 145 in which one or more of the displays 130 are located. In some instances, one or more displays 130 can be visible in the image or video. The image or video can be presented in real-time or can be previously captured. The image or video can be updated continuously and/or on any suitable basis.

In some arrangements, the select display field 502 may not include an image or video of at least a portion of the environment 145 in which one or more of the displays 130 are located. In such cases, the select display field 502 can present other suitable information to convey information about the displays that are available for presenting the advertisement or presentation. For example, a general layout (e.g. a schematic, drawing or sketch) of the environment 145 can be presented. Alternatively or in addition, a list of available displays 130 can be presented.

The send to display page 500 can include one or more user interface elements associated with each available display to allow a user to select one or more of the available displays. For instance, the user interface element(s) can include a checkbox 510 and/or a button to allow a user to select a desired display. In some instances, an identifier 515 for the display 130 can be presented proximate to the checkbox. The user interface element(s) can be arranged in the select display field 502 in any suitable manner. For instance, the user interface element(s) can be located on or near a respective one of the displays presented in the image or video. Alternatively or in addition, the user interface element(s) can be located on or near a respective one of the items presented in the image or video.

The display status field 504 can be configured to present the status of one or more displays. For instance, when the select display field 502 is an image or video as described above, the display status field 504 can present the status of one or more of the displays 130 represented in the image or video.

The display status field 504 can have any suitable form and can present any suitable information. For instance, for at least some of the displays, the display status field 504 can present one or more of the following aspects: the display name, the operational status of the display (e.g. online or offline), a status (e.g. current or most recent) of content on the display (e.g. currently displaying, latest presentation), and/or a name of the content (e.g. the name input in the presentation name field 402). These types of information are provided merely as examples and arrangements are not limited to any particular information being presented in the display status field 504. There can be more, less or different information presented for the displays listed in the display status field 504.

A user can direct the system to cause the advertising content to be published to selected displays. For instance, a user can select a suitable user interface element (e.g. a “Send to Displays” button 520). Responsive to receiving such an input, the system can published the advertising content to the selected displays for presentation thereon.

When a display 130 is powered off, an alert can be sent to one or more systems, devices, and/or components of the system 100 that the display is offline. Similarly, when a display 130 is powered on, an alert can be sent to one or more systems, devices, and/or components of the system 100 that the display is online. When such alerts are received, the system can be updated as appropriate to reflect the appropriate status of the particular display 130.

In some arrangements, it should be noted that a user can access the advertising content module(s) 120 through one or more of the displays 130. Thus, if a user wishes to update the advertising content on a particular display, then a user can access the advertising content modules(s) 120 using display 130, such as to access a portal as described above. The user can update the advertising content as desired.

In some instances, a user can load an advertising content locally onto one or more of the displays 130. A user may wish to do so when a display is in an offline mode or is otherwise not accessible. For instance, a user can have advertising content stored on a data storage device. The advertising content can be provided and/or stored in any suitable form. The display can be communicatively coupled to the data storage device. As an example, advertising content can be stored on a USB flash drive or other suitable data storage device. The USB flash drive can be inserted into an appropriate interface on the display 130. The display 130 can be configured to detect the USB flash drive and check for advertising content for local playback. If such advertising content is detected, then the advertising content can be copied or transferred onto a local storage of the display and loaded for presentation. Alternatively, the advertising content can be presented on the display directly from the storage device.

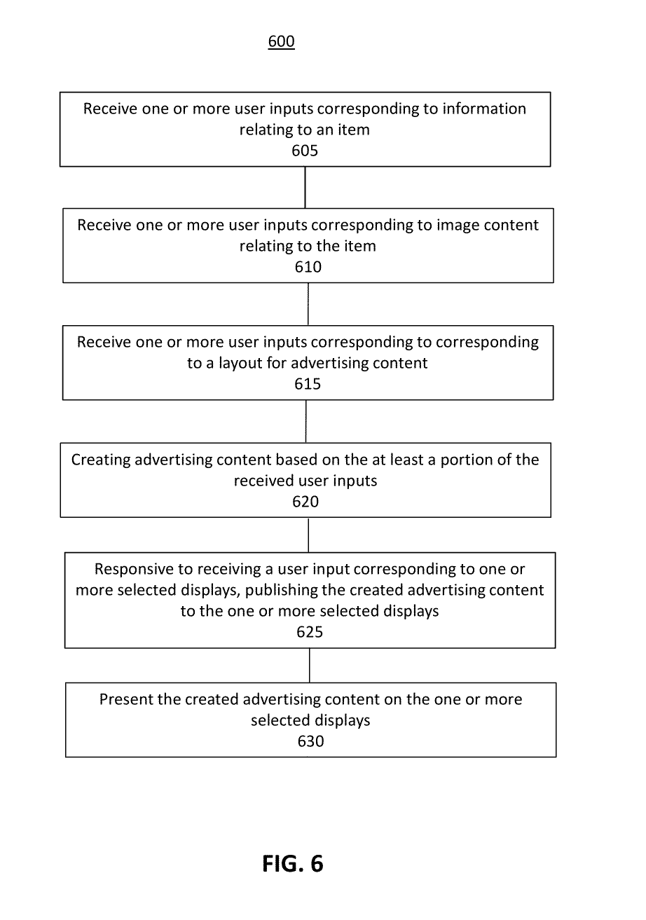

Now that the system 100 and its various components have been described, one manner of the operation of the system 100 will now be presented. Referring to FIG. 6, an example of a method 600 of creating and managing content for electronic advertising displays is shown. Various possible steps of method 600 will now be described. The method 600 illustrated in FIG. 6 may be applicable to the embodiments described herein in relation to FIGS. 1-5 and 7, but it is understood that the method 600 can be carried out with other suitable systems and arrangements. Moreover, the method 600 may include other steps that are not shown here, and in fact, the method 600 is not limited to including every step shown in FIG. 6. The steps that are illustrated here as part of the method 600 are not limited to this particular chronological order, either. Indeed, some of the steps may be performed in a different order than what is shown and/or at least some of the steps shown can occur simultaneously.

At block 605, one or more user inputs corresponding to information relating to an item can be received. At block 610, one or more user inputs corresponding to image content relating to the item can be received. At block 615, one or more user inputs corresponding to a layout for advertising content can be received. At block 620, advertising content can be created based on at least a portion of the received user inputs. At block 625, responsive to receiving a user input corresponding to one or more selected displays, publishing the created advertising content to the one or more selected displays. At block 6230, the created advertising content can be presented on the one or more selected displays.

It should be noted that a data structure can be created in the database(s) 115 for any advertising content that is created. The data structure can be populated with data objects corresponding to the received user inputs, including any of the user inputs described herein. Likewise, the data objects in an existing data structure can be modified based on one or more received user inputs.

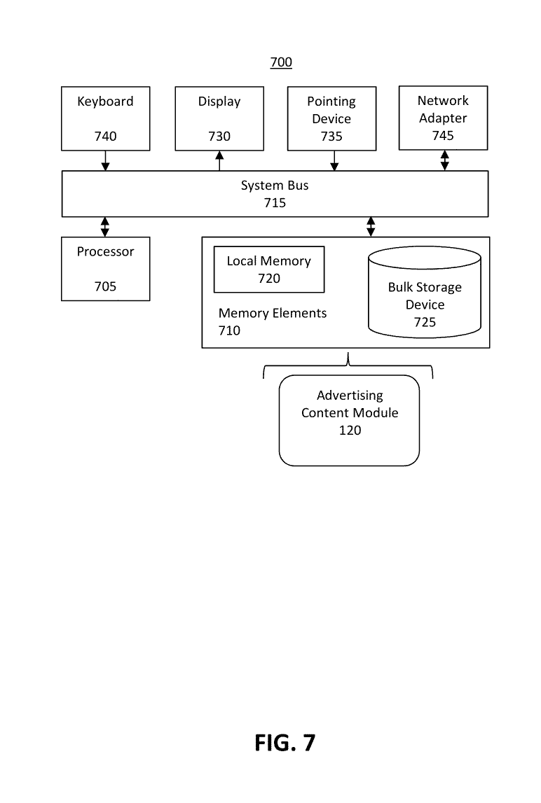

FIG. 7 is a block diagram illustrating an example of a data processing system 700. System 700 can include at least one processor (e.g., a central processing unit) 705 coupled to memory elements 710 through a system bus 715 or other suitable circuitry. As such, system 700 can store program code within memory elements 710. Processor 705 executes the program code accessed from memory elements 710 via system bus 715 or the other suitable circuitry.

In one aspect, system 700 is implemented as a computer or other programmable data processing apparatus that is suitable for storing and/or executing program code. It should be appreciated, however, that system 700 can be implemented in the form of any system including a processor and memory that is capable of performing and/or initiating the functions and/or operations described within this specification. Further, system 700 can be implemented in any of a variety of different form factors including, but not limited to, a portable device such as a mobile communication device, a tablet computing and/or communication device, a laptop computing device, a desktop computing device, a server, or the like.

Memory elements 710 include one or more physical memory devices such as, for example, local memory 720 and one or more bulk storage devices 725. Local memory 720 refers to RAM or other non-persistent memory device(s) generally used during actual execution of the program code. Bulk storage device(s) 725 can be implemented as a hard disk drive (HDD), solid state drive (SSD), or other persistent data storage device. System 700 also can include one or more cache memories (not shown) that provide temporary storage of at least some program code in order to reduce the number of times program code must be retrieved from bulk storage device 725 during execution.

Input/output (I/O) devices such as a keyboard 740, a display 730, and a pointing device 735 optionally can be coupled to system 700. The I/O devices can be coupled to system 700 either directly or through intervening I/O controllers. One or more network adapters 745 also can be coupled to system 700 to enable system 700 to become coupled to other systems, computer systems, remote printers, and/or remote storage devices through intervening private or public networks. Modems, cable modems, wireless transceivers, and Ethernet cards are examples of different types of network adapters 745 that can be used with system 700.

As pictured in FIG. 7, memory elements 710 can store the advertising content module 120. The advertising content module 120, being implemented in the form of executable program code, is executed by system 700 and, as such, is considered an integrated part of system 700. Moreover, the advertising content module 120, including any inputs, content, parameters and/or attributes utilized by module 120 and advertisements or presentations created thereby, are functional data structures that impart functionality when employed as part of system 700.

The user input data 135 and/or the advertising content 140 can be output to, and stored within, memory elements 710. As used herein, “outputting” and/or “output” can mean storing in memory elements 710, for example, writing to a file stored in memory elements 710, writing to display 730 or other peripheral output device, playing audible notifications, sending or transmitting to another system, exporting, or the like.

It will be appreciated that, as a result of arrangements described herein, one or more of the following benefits and/or other benefits can be realized. For instance, advertising content can be created, modified and/or published relatively quickly. Further, arrangements described herein can allow for advertising content to be created, modified and/or published remotely from the point at which the advertising content is displayed. Further, arrangements described herein can allow for dynamic advertising content to be created, that is, advertising content that includes moving elements and/or video, along with item specifications and/or pricing. Further, arrangements described herein can allow for the information presented on the displays to be interactive. Still further, arrangements described herein can minimize waste, as outdated signage does not have to be discarded.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. In one or more arrangements, the computer program code can be written in HTML language. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method of creating and publishing advertising content, the method comprising:
receiving one or more user inputs corresponding to information relating to an item;
receiving one or more user inputs corresponding to image content relating to the item;
creating, via a processor, advertising content, the advertising content including at least a portion of the image content relating to the item and at least a portion of the information relating to the item; and
responsive to receiving a user input corresponding to one or more selected displays, publishing the created advertising content to the one or more selected displays for presentation thereon.

2. The method of claim 1, wherein the image content relating to the item is an image file, a video file or a uniform resource locator.

3. The method of claim 1, further including:
receiving a user input corresponding to a layout for the advertising content, wherein creating advertising content includes arranging the at least a portion of the image content relating to the item and the at least a portion of the information relating to the item based on the layout.

4. The method of claim 3, further including:
presenting a plurality of predetermined layouts for the advertising content, wherein receiving a user input corresponding to a layout for the advertising content includes receiving a user input corresponding to a selected one of a plurality of predetermined layouts for the advertising content.

5. The method of claim 4, wherein the plurality of predetermined layouts includes an item information element presenting at least a portion of the received one or more user inputs corresponding to information relating to the item, wherein the plurality of predetermined layouts differ in the size of the item information element or the location of the item information element.

6. The method of claim 1, wherein receiving one or more user inputs corresponding to image content relating to the item includes receiving a plurality of user inputs corresponding to image content relating to the item.

7. The method of claim 6, further including:
receiving one or more user inputs corresponding to a presentation order for the received plurality of user inputs corresponding to image content relating to the item.

8. The method of claim 1, further including:
presenting a preview of the created advertising content.

9. The method of claim 1, further including:
presenting an image or video of at least a portion of the environment in which a plurality of displays are located; and
presenting a graphical user interface element for each display in the presented image or video, the graphical user interface element configured enable a user to select one or more of the available displays to publish the created advertising content.

10. A system of creating and publishing advertising content comprising:
a processor programmed to initiate executable operations including:
receiving one or more user inputs corresponding to information relating to an item;
receiving one or more user inputs corresponding to image content relating to the item;
creating advertising content, the advertising content including at least a portion of the image content relating to the item and at least a portion of the information relating to the item; and
responsive to receiving a user input corresponding to one or more selected displays, publishing the created advertising content to the one or more selected displays for presentation thereon.

11. The system of claim 10, wherein the image content relating to the item is an image file, a video file or a uniform resource locator.

12. The system of claim 10, wherein the processor is further programmed to initiate executable operations including:
receiving a user input corresponding to a layout for the advertising content, wherein creating advertising content includes arranging the at least a portion of the image content relating to the item and the at least a portion of the information relating to the item based on the layout, and
wherein creating advertising content includes arranging the at least a portion of the image content relating to the item and the at least a portion of the information relating to the item based on the layout.

13. The system of claim 12, wherein the processor is further programmed to initiate executable operations including:
presenting a plurality of predetermined layouts for the advertising content, wherein receiving a user input corresponding to a layout for the advertising content includes receiving a user input corresponding to a selected one of a plurality of predetermined layouts for the advertising content, and
wherein receiving a user input corresponding to a layout for the advertising content includes receiving a user input corresponding to a selected one of a plurality of predetermined layouts for the advertising content.

14. The system of claim 13, wherein the plurality of predetermined layouts includes an item information element presenting at least a portion of the received one or more user inputs corresponding to information relating to the item, wherein the plurality of predetermined layouts differ in the size of the item information element or the location of the item information element.

15. The system of claim 10, wherein receiving one or more user inputs corresponding to image content relating to the item includes receiving a plurality of user inputs corresponding to image content relating to the item.

16. The system of claim 15, wherein the processor is further programmed to initiate executable operations including:
receiving one or more user inputs corresponding to a presentation order for the received plurality of user inputs corresponding to image content relating to the item.

17. A system comprising:
a plurality of electronic displays; and
a processor communicatively coupled to the plurality of electronic displays, the processor programmed to initiate executable operations including:
receiving one or more user inputs corresponding to information relating to an item;
receiving one or more user inputs corresponding to image content relating to the item;
creating advertising content, the advertising content including at least a portion of the image content relating to the item and at least a portion of the information relating to the item; and
responsive to receiving a user input corresponding to a selected one or more of the electronic displays, publishing the created advertising content to the one or more selected electronic displays for presentation thereon.

18. The system of claim 17, wherein the processor is further programmed to initiate executable operations including:
receiving a user input corresponding to a layout for the advertising content, wherein creating advertising content includes arranging the at least a portion of the image content relating to the item and the at least a portion of the information relating to the item based on the layout, and
wherein creating advertising content includes arranging the at least a portion of the image content relating to the item and the at least a portion of the information relating to the item based on the layout.

19. The system of claim 17, wherein the processor is further programmed to initiate executable operations including:
presenting a plurality of predetermined layouts for the advertising content, wherein receiving a user input corresponding to a layout for the advertising content includes receiving a user input corresponding to a selected one of a plurality of predetermined layouts for the advertising content, and
wherein receiving a user input corresponding to a layout for the advertising content includes receiving a user input corresponding to a selected one of a plurality of predetermined layouts for the advertising content.

20. The system of claim 17, wherein the plurality of electronic displays is located in a showroom for a motorized vehicle, and wherein the item is a motorized vehicle.
